(19) United States
(12) Patent Application Publication
(10) Pub. No.: US 2026/0066363 A1
(43) Pub. Date: Mar. 5, 2026

(54) Separator and Secondary Battery

(71) Applicant: SK On Co., Ltd., Seoul (KR)

(72) Inventors: Yun Kyung JO, Daejeon (KR); Jeong Han KIM, Daejeon (KR); Whee Sung KIM, Daejeon (KR)

(21) Appl. No.: 19/308,400

(22) Filed: Aug. 25, 2025

(30) Foreign Application Priority Data
Aug. 28, 2024 (KR) 10-2024-0115572

(51) Int. Cl. H01M 10/42; H01M 50/417; H01M 50/423; H01M 50/434; H01M 50/443; H01M 50/446; H01M 50/449; H01M 50/489

(52) U.S. Cl. CPC H01M 10/4235; H01M 50/417; H01M 50/423; H01M 50/434; H01M 50/443; H01M 50/446; H01M 50/449; H01M 50/489

(57) ABSTRACT

A separator for a secondary battery includes a porous substrate, an inorganic layer including a first inorganic particle on at least one surface of the porous substrate, and an aramid resin layer including an aramid resin and a second inorganic particle on the inorganic layer, wherein an average diameter D₅₀ of a circle-equivalent particle of the second inorganic particle is less than 0.1 μm.

### CROSS-REFERENCE TO RELATED APPLICATION(S)

This patent document claims the priority and benefits of Korean Patent Application No. 10-2024-0115572 filed on Aug. 28, 2024, the disclosure of which is incorporated herein by reference in its entirety.

### TECHNICAL FIELD

The disclosure and implementations disclosed in this patent document generally relate to a separator and a secondary battery.

### BACKGROUND

With the rapid spread of portable electronic devices and the increase in demand for electric vehicles, lithium ion secondary batteries with high energy density have come to prominence as a power source for electric devices and electric vehicles.

The lithium ion secondary battery includes a multilayer body including a positive electrode, a negative electrode, and a separator interposed between the positive electrode and the negative electrode and includes an electrolyte including a lithium salt. The separator plays a role in preventing short circuits between the positive electrode and the negative electrode.

The separator also needs to have a shutdown function to block current from pore closing at high temperatures during a thermal runaway situation of the battery and further needs to have heat resistance to maintain the shutdown function, while maintaining the shape of the separator.

To this end, a polyethylene porous film may be used as the separator, and may include a coating layer of inorganic particles for heat resistance.

### SUMMARY

The present disclosure may be implemented in some embodiments to improve rapid charging performance.

The present disclosure may also be implemented in some embodiments to suppress lithium plating on a surface of a negative electrode during rapid charging.

The present disclosure may also be implemented in some embodiments to suppress wrinkles from being formed during a battery assembly process, thereby improving defects in the battery assembly process and increasing capacity.

In some embodiments of the present disclosure, a separator for a secondary battery includes: a porous substrate; an inorganic layer including a first inorganic particle, disposed on at least one surface of the porous substrate; and an aramid resin layer including an aramid resin and a second inorganic particle, disposed on the inorganic layer, wherein an average diameter D₅₀ of a circle-equivalent particle of the second inorganic particle is less than 0.1 μm.

The aramid resin may include at least one selected from the group consisting of meta-aramid and para-aramid.

The second inorganic particle may include at least one selected from the group consisting of aluminum oxide, silica, titanate and sepiolite.

The second inorganic particle may be included in an amount of 40 to 80 wt % based on a total weight of the aramid resin layer.

The aramid resin layer may have a thickness of 1 to 3 μm.

An average diameter D₅₀ of a circle-equivalent particle of the first inorganic particle is 40 nm to 1.6 μm.

The first inorganic particle may include at least one selected from the group consisting of aluminum hydroxide, magnesium hydroxide, aluminum oxide, magnesium oxide, calcium oxide, barium sulfate, boehmite, titanium dioxide, silica, or clay.

The inorganic layer may further include a binder.

The binder may include at least one selected from the group consisting of polymethylmethacrylate, polybutylacrylate, polyacrylonitrile, polyvinylpyrrolidone, polyvinylacetate, ethylene-vinyl acetate copolymer, or polyethylene oxide.

The binder may be included in an amount of 4 to 10 wt % based on a total weight of the inorganic layer.

The inorganic layer may have a thickness of 1 to 5 μm.

The porous substrate may have a thickness of 5 to 11 μm, a puncture strength of 300 gf or more, and an air permeability of 50 to 100 sec/100 cc.

The porous substrate may be a high-density polyethylene film.

The separator may have a thickness of 8 to 25 μm.

The separator may have an air permeability of 50 to 250 sec/100 cc.

The separator may have a breakdown voltage of 1.7 KV or higher.

### BRIEF DESCRIPTION OF DRAWINGS

Certain aspects, features, and advantages of the present disclosure are illustrated by the following detailed description with reference to the accompanying drawings.

FIG. 1 is a cross-sectional view schematically illustrating an example of a separator according to the present disclosure.

### DETAILED DESCRIPTION

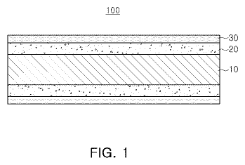

The present disclosure provides a separator for a secondary battery. An example of the separator is schematically illustrated in FIG. 1. As illustrated in FIG. 1, the separator according to an embodiment of the present disclosure may include a porous substrate 10, an inorganic layer 20 on at least one surface of the porous substrate 10, and an aramid resin layer 30 on the inorganic layer 20.

The porous substrate is an insulating substrate capable of blocking electrical contact between positive and negative electrodes, and any separator having pores allowing the movement of lithium ions in the substrate and commonly used as a separator in a secondary battery may be suitably used in the present disclosure.

The porous substrate is not particularly limited as long as it has pore characteristics and insulation and may be formed of a material including a polyolefin resin, such as polyethylene, polypropylene, an ethylene/butene copolymer, an ethylene/hexene copolymer, and an ethylene/methacrylate copolymer.

The porous substrate has pores through which lithium ions may move, and may be a microporous separator, non-woven fabric, paper, etc., in which the pores are interconnected to form a three-dimensional network through which lithium ions may move.

For example, the porous substrate may be a polyethylene film, and more specifically, a high-density polyethylene film. When the separator according to an embodiment of the present disclosure is a porous film of high-density polyethylene having the high strength characteristics as described above as a porous substrate, the electrolyte impregnation property may be improved and a phenomenon of wrinkles occurring due to stress relief may be reduced.

The porous substrate may have a thickness of, but is not limited to, 5 to 11 μm. If the thickness of the porous substrate is less than 5 μm, the handling properties may deteriorate. For example, the porous substrate may be easily broken during the process of manufacturing the separator by coating at least one surface of the porous substrate with an inorganic material and an aramid layer. Meanwhile, if the thickness of the porous substrate exceeds 11 μm, a smaller amount of electrode active material than the appropriate design of the lithium ion secondary battery may be included, which may cause a decrease in energy density.

The porous substrate may have a puncture strength of 300 gf or more, but is not limited thereto. The puncture strength may be measured by puncturing a sample with a round pin (diameter 1 mm) using a universal testing machine (UTM). If the puncture strength is less than 300 gf, unexpected foreign matter, etc. may may be mixed to easily cause separator breakage in the battery during battery assembly, which may cause a short circuit. As the puncture strength increases, the mechanical strength of the separator may be improved, which may reduce the possibility of defects due to the mixing of foreign matter, and therefore, an upper limit thereof is not particularly limited. However, a heat shrinkage rate may deteriorate as a result of the process control of the porous substrate for increasing the puncture strength, and thus, it is important to implement a high puncture strength within a desired heat shrinkage range.

The porous substrate may have, but is not limited to, a permeability of 50 to 100 sec/100 cc. If the permeability is less than 50 sec/100 cc, a voltage drop problem may occur due to self-discharge due to an excessively large or numerous pore structure, and if the permeability exceeds 100 sec/100 cc, the permeability after coating may become excessively high, which may cause problems with lifespan output characteristics required for the battery. The permeability may be measured by JIS P8117.

The porous substrate may have a porosity of 40 to 50%. If the porosity is less than 40%, the mobility of lithium ions may be reduced, and if the porosity exceeds 50%, the strength of the porous substrate may be reduced, resulting in poor handling properties.

One or both surfaces of the porous substrate may include an inorganic layer. The inorganic layer may provide mechanical strength and heat resistance characteristics to the separator according to an embodiment of the present disclosure. The improvement in the mechanical strength may improve phenomena, such as the thickness of the battery increasing due to the formation of wrinkles in the separator within the battery or misalignment between the positive and negative electrodes. The heat resistance characteristics may play a role in delaying or preventing the expansion of a short circuit range if a micro-short circuit occurs within the battery. In addition, the inorganic layer may have breathability due to a gap between inorganic particles, thereby providing mobility of lithium ions.

The inorganic layer may include a first inorganic particle. The first inorganic particle may include, but is not limited to, at least one selected from the group consisting of aluminum hydroxide, magnesium hydroxide, aluminum oxide, magnesium oxide, calcium oxide, barium sulfate, boehmite, titanium dioxide, silica, or clay.

The first inorganic particle may have, but is not limited to, an average diameter D₅₀ of a circle-equivalent particle of 40 nm to 1.6 μm. The average diameter D₅₀ may be measured using a particle size analyzer and represents the diameter of the 50th particle assuming that 100 particles are arranged by particle size. If the average diameter D₅₀ of the circle-equivalent particle of the first inorganic particle is less than 40 nm, the dispersibility of a coating layer slurry may be poor, and if the average diameter D₅₀ of the circle-equivalent particle of the first inorganic particle exceeds 1.6 μm, it may be difficult to implement a desired level of coating layer thickness.

The inorganic layer may further include a binder. The binder may provide a bonding force between inorganic particles of the inorganic layer. The binder may include at least one selected from the group consisting of polymethylmethacrylate, polybutylacrylate, polyacrylonitrile, polyvinylpyrrolidone, polyvinylacetate, ethylene-vinyl acetate copolymer, and polyethylene oxide.

The binder may be included in an amount of 4 to 10 wt % based on the total weight of the inorganic layer. If the content of the binder is less than 4 wt %, the coating layer may be separated from the substrate, and if the content of the binder exceeds 10 wt %, the ion migration resistance may increase.

The inorganic layer may have a thickness of, for example, 1 to 5 μm, but is not limited thereto. If the thickness of the inorganic layer is less than 1 μm, an uncoated portion may occur, and if the thickness of the inorganic layer exceeds 5 μm, the entire thickness of the separator may increase, thereby increasing a cell thickness.

The inorganic layer may include a surfactant, such as sodium dioctylsulfosuccinate, sodium lauryl sulfate, potassium salt of a higher fatty acid, polyoxyethylene tridecyl ether phosphate ester, or polyoxyethylene alkyl (C8) ether phosphate ester monoethanol amine salt to improve the wettability of the inorganic particles. In addition, the inorganic layer may include a dispersant including various polymers and salts thereof to stabilize the particle diameter of the inorganic particles.

The separator according to an embodiment of the present disclosure may include an inorganic layer on one or both surfaces of the porous substrate and the aramid resin layer on the inorganic layer.

The aramid resin layer includes an aramid resin, and the aramid resin has heat resistance, and thus may further improve the heat resistance of the separator. The separator including the aramid resin layer may maintain the shape of the separator when the battery is abnormally heated, thereby suppressing the occurrence of an internal short circuit. In addition, the aramid resin layer may form a finer pore layer than the porous substrate and the inorganic layer, thereby contributing to delaying the occurrence of lithium plating during rapid charging.

The aramid resin is not particularly limited, but may include at least one selected from the group consisting of meta-aramid and para-aramid, for example. The meta-aramid may have a thermal decomposition temperature of 400° C. or higher, and the para-aramid may have a thermal decomposition temperature of 500° C. or higher. In this manner, the aramid resin may have a higher thermal decomposition temperature than a polyolefin resin, such as high-density polyethylene, provided as the porous substrate, and thus may provide heat resistance to the separator.

The aramid resin layer may also include a second inorganic particle.

The average diameter D₅₀ of the circle-equivalent particle of the second inorganic particle may be less than 0.1 μm, and specifically, may be 0.08 μm or less.

The second inorganic particles may provide flat surface characteristics to the substrate surface or the inorganic layer surface and may form a dense pore structure to prevent or suppress the occurrence of lithium plating on the negative electrode surface and suppress a phenomenon of desorption from the aramid resin layer.

That is, if the average diameter D₅₀ of the circle-equivalent particle of the second inorganic particles is 0.1 μm or more, it may be difficult to provide the flat surface characteristics for the separator disposed between the electrodes and it may be difficult to provide a dense pore structure for the aramid resin layer, which may cause Li-plating to occur more easily on the negative electrode surface. In addition, when the average diameter of the circle-equivalent particle of the second inorganic particles is within the range, the second inorganic particles are mixed with a strong cohesive force in the aramid resin layer, so that dust occurrence due to detachment of the second inorganic particles from the aramid resin layer by external force applied by a grip, etc. during an assembly process of the separator by a worker during the battery assembly process may be prevented.

The second inorganic particles may include, but are not limited to, at least one selected from the group consisting of aluminum oxide, silica, titanate, and sepiolite.

The second inorganic particles may be included in an amount of 40 to 80 wt % based on the total weight of the aramid resin layer. If the content of the second inorganic particles is less than 40 wt %, it may be difficult to form a uniform pore structure suitable for ion mobility, and if the content of the second inorganic particles exceeds 80 wt %, the formation of a micro-pore structure due to an aramid resin may be incomplete.

The aramid resin layer may have a thickness of 1 to 3 μm. If the thickness of the aramid resin layer is less than 1 μm, the performance improvement during rapid charging may be insufficient, and if the thickness of the aramid resin layer exceeds 3 μm, the aramid resin layer may act as a resistance of the battery, thereby reducing the lifespan and high-rate charging/discharging characteristics of the battery.

The aramid resin layer may be manufactured by adding the aramid resin and the second inorganic particles to a solvent, stirring the mixture to prepare a slurry, and then applying the slurry to the inorganic material layer. At this time, the solvent is not limited thereto but may include N,N-dimethylformamid, N,N-dimethylacetamide, N-methyl-2-pyrrolidone, tetramethylurea, and the like. Any one of the solvents may be used alone, or two or more may be mixed and used.

The separator including the aramid resin layer may include pores for the movement of lithium ions, and therefore the aramid resin layer may include pores.

The separator for a secondary battery according to an embodiment of the present disclosure may be a separator for a secondary battery including the porous substrate, the inorganic layer including first inorganic particles on at least one surface of the porous substrate, and the aramid resin layer including an aramid resin and second inorganic particles on the inorganic layer, in which an average diameter of a circle-equivalent particle of the second inorganic particles is less than 0.1 μm on average.

The separator may provide a shutdown function by blocking the movement of lithium ions by closing the pores of the porous substrate when the temperature of the battery rises to an abnormal state. In addition, even if the porous substrate shrinks in an abnormal high temperature situation, the inorganic layer and the aramid resin layer disposed on the porous substrate may prevent direct contact between the negative electrode and the positive electrode, thereby preventing a short circuit phenomenon.

Furthermore, since the aramid resin layer disposed on the surface of the separator includes the second inorganic particles having a predetermined diameter, the separator having a flat surface between the positive electrode and the negative electrode may be provided, and a dense pore structure may be provided in the aramid resin layer, thereby preventing or delaying lithium plating on the surface of the negative electrode. Therefore, when the separator is included in a lithium secondary battery, battery safety may be improved and rapid charging performance may be enhanced.

The separator provided in an embodiment of the present disclosure may have a thickness of 8 to 25 μm. If the thickness of the separator is less than 8 μm, the separator may be easily torn during the battery assembly process and use, or a voltage drop problem may occur due to self-discharge, and if thickness of the separator exceeds 25 μm, the battery may become excessively thick and the use amount of electrode active material may be reduced when implementing a battery having the same thickness, which may cause a decrease in capacity.

The separator may include pores forming a three-dimensional network. Lithium ions may move through the pores. The separator may have a permeability of 50 to 250 sec/100 cc. The permeability of the separator may be measured by JIS P8117. If the permeability is less than 50 sec/100 cc, the mechanical strength of the separator may decrease, and if it exceeds 250 sec/100 cc, separator resistance of the separator may increase.

The separator may have a breakdown voltage of 1.7 KV or more. If the breakdown voltage of the separator is less than 1.7 KV, a defect rate in the process of checking the insulation properties during the battery assembly process may increase.

The separator may exhibit a pore closure temperature of about 140° C. and a shrinkage rate of 10% or less when left at 130° C. for 1 hour.

### Example

Hereinafter, examples of the present disclosure will be additionally described with reference to specific experimental examples. The examples and comparative examples included in the experimental examples are only illustrative of the present disclosure and do not limit the scope of the appended claims. It is obvious to those skilled in the art that various changes and modifications may be made to the examples within the scope and technical idea of the present disclosure, and it is also natural that such changes and modifications fall within the scope of the appended claims.

### Manufacturing of Separator

### Examples 1 to 4 and Comparative Examples 1 to 4

A porous film formed of high-density polyethylene (HDPE) having the thickness, puncture strength, air permeability, and porosity as shown in Table 1 was prepared.

An inorganic layer including a first inorganic particles of boehmite (BM) and a binder (B) of polymethylmethacrylate (PMMA) was formed on both surfaces of the HDPE porous film having the thickness as shown in Table 1. In Example 3, two types of boehmite (BM) having average particle diameter D₅₀ of 0.3 μm and 1.6 μm were mixed in a 1:1 ratio and used.

The inorganic layer was prepared by mixing pure water and the first inorganic particles as a solvent, pre-dispersing, mixing a binder to form an inorganic slurry, continuously applying the corresponding inorganic slurry to the porous film using a bar coater, and then continuously allowing the same to pass through a drying oven at a temperature of 80 to 110° C.

Furthermore, an aramid resin layer including an aramid resin (AM) of para-aramid (p-AM) and a second inorganic particles of alumina (Al₂O₃) was formed on both surfaces of the inorganic layer to have a thickness as shown in Table 1.

The aramid resin layer was manufactured by adding the second inorganic particles and the aramid resin to N,N-dimethylformamid as a solvent and stirring to make a coating slurry, applying the slurry to the surface of the separator including the inorganic material layer using a bar coater, immersing the same in a water tank to implement a pore structure in the aramid resin layer, and then continuously allowing it to pass through a drying oven at a temperature of 80 to 110° C.

As a result, the separator having the thickness as shown in Table 1 was obtained.

TABLE 1

| | | | | Example | | | | Comparative Example | | | |
|---|---|---|---|---|---|---|---|---|---|---|---|
| | | | | 1 | 2 | 3 | 4 | 1 | 2 | 3 | 4 |
| Porous | Thickness (μm) | | | 8 | 9 | 8 | 9 | 9 | 8.5 | 8 | 8.1 |
| substrate | Puncture strength | | | 400 | 440 | 360 | 430 | 380 | 470 | 400 | 240 |
| | (gf) | | | | | | | | | | |
| | Air permeability | | | 80 | 95 | 68 | 87 | 65 | 97 | 70 | 100 |
| | (sec/100 cc) | | | | | | | | | | |
| | Porosity (%) | | | 45 | 44 | 48 | 46 | 51 | 45 | 50 | 43 |
| Organic | Composition | First | Kind | BM | BM | BM | BM | BM | — | BM | — |
| layer | | organic | Diameter | 0.3 | 1.6 | 0.3 | 0.7 | 0.2 | — | 0.7 | — |
| | | material | (μm) | | | 1.6 | | | | | |
| | | Kind of | | PMMA | PMMA | PMMA | PMMA | PMMA | — | PMMA | — |
| | | binder (B) | | | | | | | | | |
| | | wt % | | 97:3 | 95:5 | 96:4 | 95:5 | 89:11 | — | 95:5 | — |
| | | (First | | | | | | | | | |
| | | organic | | | | | | | | | |
| | | material:B) | | | | | | | | | |
| | thickness (μm) | | | 2 | 2 | 3 | 3 | 4 | 0 | 2 | 0 |
| Aramid | Composition | Kind of AM | | p-AM | p-AM | p-AM | p-AM | — | p-AM | p-AM | p-AM |
| resin | | Second | Kind | Al₂O₃ | Al₂O₃ | Al₂O₃ | Al₂O₃ | — | Al₂O₃ | Al₂O₃ | Al₂O₃ |
| layer | | inorganic | Diameter | 0.04 | 0.04 | 0.06 | 0.08 | — | 0.04 | 0.1 | 0.08 |
| | | material | (μm) | | | | | | | | |

| | | | | | | | | |
|---|---|---|---|---|---|---|---|---|
| Wt % | 40:60 | 70:30 | 50:50 | 60:40 | — | 70:30 | 50:50 | 60:40 |
| (AM:Second | | | | | | | | |
| inorganic | | | | | | | | |
| particles) | | | | | | | | |

| | | | | | | | | | |
|---|---|---|---|---|---|---|---|---|---|
| | Thickness (μm) | 3 | 2 | 3 | 2 | 0 | 3 | 3 | 3 |
| Separator | Thickness (μm) | 13 | 13 | 14 | 14 | 13 | 11.5 | 13 | 11 |

### Evaluation of Characteristics of Separator

For each of the manufactured separators, the thickness, air permeability, shrinkage rate, and breakdown voltage were measured using the following methods, and the results are shown in Table 2.

Thickness (μm): Measured using a VL50 series thickness measuring instrument from Mitutoyo.

Air permeability (sec/100 cc): Measured according to JIS P8117.

Shrinkage rate (%): A 100 mm straight line in the MD and TD directions of the separator was drawn, sandwiched between A4-sized papers, and left at 130° C. for 1 hour using an insulating chamber. A change in the length of the drawn straight line was checked, and a changed length was expressed as %.

Breakdown voltage BDV (KV) The separator was disposed on a metal plate, voltage was applied at a constant rate in the range of 0 to 5 KV using an external DC power source, and a point at which 5 mA of current flows is considered a point of dielectric breakdown, and a breakdown voltage (BDV) was recorded.

TABLE 2

| Physical | Example | | | | Comparative Example | | | |
|---|---|---|---|---|---|---|---|---|
| properties | 1 | 2 | 3 | 4 | 1 | 2 | 3 | 4 |
| Thickness (μm) | 13 | 13 | 14 | 14 | 13 | 11.5 | 13 | 11 |
| Whether to include | ◯ | ◯ | ◯ | ◯ | ◯ | X | ◯ | X |
| inorganic layer | | | | | | | | |
| Whether to include | ◯ | ◯ | ◯ | ◯ | X | ◯ | ◯ | ◯ |
| aramid resin layer | | | | | | | | |
| Air permeability | 189 | 202 | 176 | 185 | 172 | 194 | 183 | 180 |
| (sec/100 cc) | | | | | | | | |
| Shrinkage rate | 4 | 5 | 5 | 3.5 | 5 | 3 | 5 | 3 |
| (130° C. 1 hr, %) | | | | | | | | |
| Breakdown volage | 2.3 | 2.35 | 2.1 | 2.2 | 1.6 | 2.4 | 2.2 | 1.4 |
| (BDV) (KV) | | | | | | | | |

As can be seen from Table 2, the separators of Examples 1 to 4, which include both a porous substrate, an inorganic layer, and an aramid resin layer, have high breakdown voltage of 2.1 kV or more, excellent shrinkage rate of 5% or less, and excellent air permeability characteristics of 202 sec/100 cc or less. In contrast, the separator of Comparative Example 1 has a similar structure to that of the separator of Example 1 but exhibits poor breakdown voltage and thermal shrinkage rate, and the separator of Comparative Example 4 exhibits poor breakdown voltage characteristics.

### Manufacturing of Battery

A positive electrode including an NCM 811 positive electrode active material having a nickel content of 80% or more and an negative electrode including an negative electrode active material mixed with artificial graphite and natural graphite were prepared. In addition, a mixed electrolyte solution including ethylene carbonate (EC), ethyl methyl carbonate (EMC), and diethyl carbonate (DEC) in which 1M lithium hexafluorophosphate (LiPF₆) was dissolved was prepared.

An electrode assembly was manufactured using the positive and negative electrodes and each of the separators manufactured in Examples and Comparative Examples.

The electrode assembly was stored in a pouch case, and the electrolyte solution was injected and sealed to manufacture a pouch-type secondary battery.

The manufactured pouch-type secondary battery was evaluated as follows, and the results are shown in Table 3.

Evaluation of wrinkle occurrence inside the cell: After completing a cell finishing process on the manufactured secondary battery, the battery was disassembled and wrinkles were observed in the area of ⅓ or more of the width of the separator in the direction of the release of the separator. A case in which wrinkles were observed was determined as Fail.

Rapid charge time (SOC 8 to 80%, min): After charging to SOC 8% at a C rate of ⅓C, the time taken to achieve SOC 8 to 80% by lowering the C-rate by 0.25 C each time the charge limit is reached, starting at 2.75 C, and charging to 1 C, was measured and illustrated as the rapid charge time in Table 3. When the rapid charge time is checked to be within 30 minutes, the metal charging performance may be evaluated as excellent.

Li-plating occurrence: A point at which the charge limit is reached may be determined as the charge limit at which Li-plating occurs, and the point at which the charge limit is reached may be determined as a point at which a negative potential slope on a dV/dQ graph changes, that is, a point at which the rate at which the negative potential falls changes (inflection point).

After 100 cycles of rapid charging under the same conditions as above, the electrodes were disassembled and visually observed to determine whether Li-plating occurred on the positive electrode surface, and the results are shown in Table 3.

Penetration (2 mmΦ pin, 80 mm/sec, SOC 70%): A battery with a charge rate of 70% was penetrated at a speed of 80 mm/sec with a pin having a diameter of 2 mm, and a case without ignition or explosion was determined as Pass.

Overcharge (1 C, CC/CV, 2.5 hr, 5.0V): A battery with a charge rate of 100% was placed in an insulated chamber and charged for 2.5 hours under 5V conditions at a charge rate of 1 C using a constant current/constant voltage method. A case without ignition or explosion was determined as Pass.

Discharge capacity retention rate (%) after 600 cycles: The discharge capacity after 600 cycles at a charge/discharge rate of 1 C under a temperature condition of 45° C. in the SOC 2-96% range was measured and shown in Table 3. A case in which the discharge capacity retention rate was 80% or higher as a result of the evaluation was determined as Pass.

TABLE 3

| | Example | | | | Comparative Example | | | |
|---|---|---|---|---|---|---|---|---|
| Physical properties | 1 | 2 | 3 | 4 | 1 | 2 | 3 | 4 |
| Evaluation of wrinkle | Pass | Pass | Pass | Pass | Pass | Fail | Pass | Fail |
| occurrence inside cell | | | | | | | | |
| Rapid charging time | 29.3 | 29.7 | 28.9 | 29.6 | 30.9 | 30.5 | 34.0 | 30.4 |
| (SOC 8-80%, min) | | | | | | | | |
| Occurrence of Li | Absence | Absence | Absence | Absence | Presence | Absence | Presence | Absence |
| plating | | | | | | | | |
| Discharge capacity | 87 | 84 | 81 | 82 | 82 | 76 | 83 | 83 |
| retention rate (%) | | | | | | | | |
| after 600 cycles | | | | | | | | |
| Hi-Pot test | Pass | Pass | Pass | Pass | Fail | Pass | Pass | Fail |
| Penetration (2 mmΦpin, | Pass | Pass | Pass | Pass | Pass | Pass | Pass | Pass |
| 80 mm/sec, SOC 70%) | | | | | | | | |
| Overcharge (1 C, CC/CV, | Pass | Pass | Pass | Pass | Pass | Pass | Pass | Pass |
| 2.5 hr, 5.0 V) | | | | | | | | |

As can be seen from Table 2 above, the separators of Comparative Examples 2 and 3 showed comparable results to the separators of Examples in terms of air permeability, shrinkage rate, and breakdown voltage evaluations, but as can be seen from Table 3 above, the batteries including the separators of Comparative Examples 2 and 3 showed inferior results in terms of rapid charging time. In addition, the separator of Comparative Example 2 showed wrinkles observed inside the cell, and the discharge capacity retention rate after 600 cycles was only 76%. In addition, the separator of Comparative Example 3 was evaluated to have Li-plating formed. Furthermore, as can be seen from Table 3 above, the batteries including the separators of Examples 1 to 4 showed rapid charging times less than 30 minutes, and it was found that the rapid charging time was improved by about 1 minute compared to the batteries including the separators manufactured in Comparative Examples 1 to 4. In addition, all of the batteries including the separators of Examples passed the Hi-Pot test, but there were cases in which the batteries including the separators of Comparative Examples 1 and 4 did not pass.

According to an embodiment of the present disclosure, lithium plating on the surface of the negative electrode may be suppressed even during rapid charging, and rapid charging performance may be improved, thereby improving battery performance.

The separator according to an embodiment of the present disclosure may suppress the problem of wrinkle formation, and thus may suppress defects during the alignment process of the battery.

The separator according to an embodiment of the present disclosure may improve battery safety and rapid charging characteristics.

The separator of the present disclosure may be widely applied in green technology fields, such as electric vehicles, battery charging stations, and other solar power generation and wind power generation using batteries. In addition, the separator of the present disclosure may be used in eco-friendly electric vehicles, hybrid vehicles, etc. to prevent climate change by suppressing air pollution and greenhouse gas emissions.

Only specific examples of implementations of certain embodiments are described. Variations, improvements and enhancements of the disclosed embodiments and other embodiments may be made based on the disclosure of this patent document.

What is claimed is:

1. A separator for a secondary battery, the separator comprising:
a porous substrate;
an inorganic layer including a first inorganic particle, disposed on at least one surface of the porous substrate; and
an aramid resin layer including an aramid resin and a second inorganic particle, disposed on the inorganic layer,
wherein an average diameter D₅₀ of a circle-equivalent particle of the second inorganic particle is less than 0.1 μm.

2. The separator of claim 1, wherein the aramid resin includes at least one selected from the group consisting of meta-aramid and para-aramid.

3. The separator of claim 1, wherein the second inorganic particle includes at least one selected from the group consisting of aluminum oxide, silica, titanate and sepiolite.

4. The separator of claim 1, wherein the second inorganic particle is included in an amount of 40 to 80 wt % based on a total weight of the aramid resin layer.

5. The separator of claim 1, wherein the aramid resin layer has a thickness of 1 to 3 μm.

6. The separator of claim 1, wherein an average diameter D₅₀ of a circle-equivalent particle of the first inorganic particle is 40 nm to 1.6 μm.

7. The separator of claim 1, wherein the first inorganic particle includes at least one selected from the group consisting of aluminum hydroxide, magnesium hydroxide, aluminum oxide, magnesium oxide, calcium oxide, barium sulfate, boehmite, titanium dioxide, silica, and clay.

8. The separator of claim 1, wherein the inorganic layer further includes a binder.

9. The separator of claim 8, wherein the binder includes at least one selected from the group consisting of polymethylmethacrylate, polybutylacrylate, polyacrylonitrile, polyvinylpyrrolidone, polyvinylacetate, ethylene-vinyl acetate copolymer, and polyethylene oxide.

10. The separator of claim 8, wherein the binder is included in an amount of 4 to 10 wt % based on a total weight of the inorganic layer.

11. The separator of claim 1, wherein the inorganic layer has a thickness of 1 to 5 μm.

12. The separator of claim 1, wherein the porous substrate has a thickness of 5 to 11 μm, a puncture strength of 300 gf or more, and an air permeability of 50 to 100 sec/100 cc.

13. The separator of claim 1, wherein the porous substrate is a high-density polyethylene film.

14. The separator of claim 1, wherein the separator has a thickness of 8 to 25 μm.

15. The separator of claim 1, wherein the separator has an air permeability of 50 to 250 sec/100 cc.

16. The separator of claim 1, wherein the separator has a breakdown voltage of 1.7 KV or higher.
